(19) United States
(12) Patent Application Publication
(10) Pub. No.: US 2026/0126818 A1
(43) Pub. Date: May 7, 2026

(54) COMPUTER-BASED ORCHESTRATION OF AUTONOMOUS VEHICLE MOVEMENT

(71) Applicant: International Business Machines Corporation, Armonk, NY (US)

(72) Inventors: Sanehiro FURUICHI, Setagaya-ku (JP); Akira SAITO, Ichikawa-shi (JP); Kenichi TAKASAKI, Tokyo (JP); Mitsuru CHINEN, Yokohama-shi (JP); Takeshi WATANABE, Kawasaki (JP); Tsend Ochir BAT ULZII, Edogawa-ku (JP); Yohkichi SASATANI, Yokohama-city (JP); Yuhko Kanoh HASEGAWA, Koto-ku (JP)

(21) Appl. No.: 18/935,411

(22) Filed: Nov. 1, 2024

(51) Int. Cl. G05D 1/698

(52) U.S. Cl. CPC G05D 1/6985

(57) ABSTRACT

In some implementations, a management system may receive a request from an independent moving object. The management system may determine, based on the request, a group of moving objects including a leader moving object. The management system may transmit, to the leader moving object, group information to enable the independent moving object to join the group of moving objects.

### BACKGROUND

The present invention relates to autonomous vehicles, and more particularly to the field of movement of autonomous vehicles.

An autonomous vehicle (also referred to as “autonomous car” or “autonomous car”) is any motorized vehicle that is capable of operating with reduced input from a human operator or capable of operating without input from a human operator. For example, autonomous vehicles are responsible for driving activities, such as perceiving the environment, monitoring important systems, and controlling the vehicle, which includes navigating from origin to destination.

### SUMMARY

In some implementations, a computer-implemented method includes receiving a request from an independent moving object; determining, based on the request, a group of moving objects including a leader moving object; and transmitting, to the leader moving object, group information to enable the independent moving object to join the group of moving objects.

In some implementations, a management system includes one or more memories; and one or more processors, coupled to the one or more memories, configured to: receive a request from an independent moving object; determine, based on the request, a group of moving objects including a leader moving object; and transmit, to the leader moving object, group information to enable the independent moving object to join the group of moving objects.

In some implementations, a non-transitory computer-readable medium storing a set of instructions includes one or more instructions that, when executed by one or more processors of a management system, cause the management system to: receive a request from an independent moving object; determine, based on the request, a group of moving objects including a leader moving object; and transmit, to the leader moving object, group information to enable the independent moving object to join the group of moving objects.

### BRIEF DESCRIPTION OF THE DRAWINGS

FIG. 1 is a diagram of an example system described herein.

FIG. 2 is a diagram of example components of the system described herein.

FIGS. 3A-7C are diagrams of example implementations described herein.

FIGS. 8A-8C are flowcharts of an example process associated with organizing movement of autonomous vehicles.

FIG. 9 is a diagram of an example computing environment in which systems and/or methods described herein may be implemented.

FIG. 10 is a diagram of example components of one or more devices of FIG. 1.

FIG. 11 is a flowchart of an example process associated with organizing movement of autonomous vehicles.

### DETAILED DESCRIPTION

The following detailed description of example implementations refers to the accompanying drawings. The same reference numbers in different drawings may identify the same or similar elements.

Advanced technologies such as autonomous driving and platooning have been applied to personal mobility devices, such as electric carts and electric wheelchairs. Electric carts and electric wheelchairs have been predominantly used as walking aids for elderly individuals and disabled individuals. The electric carts and electric wheelchairs may be referred to as micromobility vehicles. Typically, such micromobility vehicles operate at a low speed (e.g., a speed below a threshold speed, such as up to 5 km/h). However, micromobility vehicles with comfort during operation and high-speed performance have emerged.

Autonomous electric carts, electric wheelchairs, and delivery robots are designed to travel at low speeds (e.g., up to 5 km/h) on sidewalks or road shoulders, thereby coexisting with pedestrians. In some instances, micromobility vehicles may operate as platoons. A platoon, as used herein, may refer to a group of vehicles that travel together (e.g., as a group) at a same speed and brake (e.g., apply the brakes) together.

Conventional platoon management methods and micromobility vehicles are subject to several technical problems. For example, conventional platoon management methods do not account for vehicles equipped with different driving modes. A “driving mode,” used herein, may refer to a speed or a range of speed of a micromobility vehicle. For example, a first driving mode may refer to a speed of up 5 km/h, a second driving mode may refer to a speed of 6 km/h to 15 km/h, a third driving mode may refer to a speed of 16 km/h to 30 km/h.

Because conventional platoon management methods and micromobility vehicles do not account for the different driving modes, a micromobility vehicle (with the ability to operate in different driving modes) is restricted to operating on a single path. For example, conventional platoon management methods prevent the micromobility vehicle from driving on a sidewalk using a first driving mode, driving on a bicycle lane using a second driving mode, driving on a road using a third driving mode, and so on.

Additionally, platooning with micromobility vehicles assumes the formation of a convoy with vehicles of the same performance traveling at low speeds. Accordingly, conventional platoon management methods prevent the micromobility vehicle from forming different platoons with different vehicles operating at different speeds. Therefore, conventional platoon management methods prevent efficient use of micromobility vehicles that have the ability to operate in different driving modes. For example, conventional platoon management methods prevent the micromobility vehicle from operating in different driving modes, thereby efficiently using different paths (e.g., by switching from a roadway to a bicycle lane in the event of a congestion on the roadway).

Additionally, conventional platoon management methods prevent dynamic changes to a formation of a platoon. A “formation,” as used herein, may refer to a physical arrangement of vehicles of the platoon. For example, the formation may refer to a number of rows of vehicles and a number of vehicles per row. For example, conventional platoon management methods prevent changes to the physical arrangement in order to avoid congestion on the roadway.

Switching the driving modes of individual vehicles does not dynamically change the physical formation, speed, travel division, or applicable regulations of the platoon. Therefore, a need exists for a new platoon management method that accounts for vehicles that operate in multiple driving modes. Furthermore, a need exists for forming a platoon with other micromobility vehicles or general vehicles in order to improve road space utilization efficiency and enhance safety through shared computational resources.

Implementations described herein are directed to addressing the technical problems discussed above regarding conventional platoon management methods. For example, implementations described herein are directed to managing a formation of groups of moving objects operating in multiple driving modes. A “moving object,” as used herein, may refer to an autonomous vehicle. An autonomous vehicle may include micromobility vehicles, such as electric carts, electric wheelchairs, golf carts, and delivery robots. The groups of moving objects may include platoons of autonomous vehicles. In some examples, a trip of an autonomous vehicle may be centrally managed by planning a formation of a platoon and a route for the trip for different driving mode.

In some examples, a first driving mode (also referred to as “low-speed mode”) may refer to an autonomous vehicle driving alone or in a small-sized platoon (e.g., two or three vehicles) as slowly as pedestrians (e.g., a speed of a pedestrian). A second driving mode (also referred to as “mid-speed mode”) may refer to an autonomous vehicle driving as fast as bicycles and electric scooters and forming a mid-sized platoon. The number of vehicles in a mid-size platoon may depend on a size of the vehicles. For example, depending on the size of the vehicles, the mid-size platoon may include three to six vehicles. Similarly, depending on the size of the vehicles, a large-size platoon may include six to twelve vehicles. A third driving mode (also referred to as “high-speed mode”) may refer to an autonomous vehicle driving at a speed equivalent to a motor vehicle (e.g., a car and/or a truck) and forming a large-sized platoon.

A driving mode may allow each vehicle to comply with traffic regulations for each driving mode. As an autonomous vehicle switches between different driving modes, different driving logic and regulations may be applied.

Implementations described herein enable an autonomous vehicle, operating in multiple driving modes, to join a platoon of vehicles operating in a same driving mode as the autonomous vehicle. Additionally, implementations described herein enable the autonomous vehicle to join a platoon of vehicles operating in a driving mode different than the driving mode of the autonomous vehicle. In this regard, the autonomous vehicle may switch from operating in a current driving mode to operating in the driving mode of the platoon. The platoon may be formed with vehicles with a single driving mode (e.g., general motor vehicles like truck) and with vehicles operating in multiple driving mode (e.g., micromobility vehicles).

Implementations described herein are directed to a system that may determine a trip plan for an autonomous vehicle and for a platoon of vehicles to enable different vehicles to join and leave the platoon. In some examples, the trip may be determined based on various factors, such as an origin (or departing location) of the autonomous vehicle, a destination of the autonomous vehicle, a selected departure time for the trip, a selected arrival time for the trip, and vehicle capabilities like driving performance and computing resources.

The system may determine the trip with the assumption that the autonomous vehicle operates in multiple driving modes and the autonomous vehicle is authorized to change driving mode as the autonomous vehicle is traveling (e.g., along a route) to join one or more platoons or to select an appropriate route. The system may determine the trip with the assumption that the autonomous vehicle is allowed to repeatedly join and leave different platoons by changing driving mode before arriving at the destination (e.g., a final destination). In some examples, the system may include a mobile as a service (MaaS) system.

In some examples, the system may determine and rearrange relative positions of autonomous vehicles while driving to enable additional autonomous vehicles to easily join or leave the platoon. Additionally, the system may change a driving mode of the platoon. In some examples, a preference of the passenger may be considered when selecting the driving mode. The preference of the passenger may relate to a measure of comfort during travels, a speed of travel, a length of travel time, a measure of visibility to an environment surrounding a vehicle, among other examples. For example, if a passenger prefers comfort during travels instead of a speed of travel and/or a shorter length of travel time, the vehicle may select the first driving mode or the second driving mode even if the vehicle can operate in the third driving mode. As another example, if a passenger prefers seeing landscape during the travel, the vehicle may be located in a front position or in a lateral/side position of the platoon. Furthermore, safety and comfortableness for each passenger can be considered to decide the formation of the platoon. A single vehicle can be regarded as a platoon.

In some implementations, a formation of a platoon and a route of a trip may be changed based on dynamic events, such as unexpected traffic, a vehicle blocking a lane, among other examples. For example, the formation of a platoon and/or a driving mode of the platoon can be dynamically changed depending on surrounding conditions detected by vehicles in the platoon and real-time road conditions managed using a cloud system, such as connected vehicle technology (e.g., connected vehicle insights). For example, a platoon operating in third driving mode may be reorganized to operate in a first driving mode when a traffic congestion is detected on the route.

By changing the driving mode, the platoon may be able to select an alternative route to avoid the traffic congestion. In some examples, the autonomous vehicle may operate as a transportation vehicle (e.g., operate as a taxi to transport passengers). In this regard, the autonomous vehicle (without a passenger) may join a platoon so that passengers may be picked and dropped off along a route traveled by the platoon. A platoon may also be rearranged with neighboring platoons if one or more vehicles change their destination on the way.

While examples described herein discuss autonomous vehicles, implementations described may be applicable to semi-autonomous vehicles. Additionally, while examples described herein discuss micromobility vehicles, implementations described may be applicable to other types of vehicles, such as cars, trucks, among other examples.

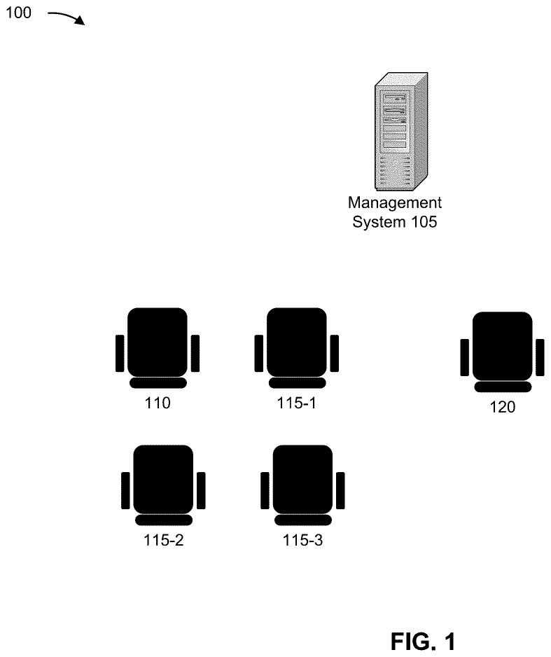

FIG. 1 is a diagram of an example system 100 described herein. As shown in FIG. 1, system 100 may include a management system 105, a leader moving object 110, a first follower moving object 115-1, a second follower moving object 115-2, a third follower moving object 115-3 (collectively “follower moving objects 115”), and an independent moving object 120. Management system 105, leader moving object 110, follower moving objects 115, and/or independent moving object 120 may communicate via a network. The network, formed by the devices shown in FIG. 1, may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

Management system 105 includes one or more devices capable of receiving, generating, storing, processing, providing, and/or routing information associated with organizing movement of autonomous vehicles as described elsewhere herein. Management system 105 may include a communication device and/or a computing device. For example, management system 105 may include a server, such as an application server, a client server, a web server, a database server, a host server, a proxy server, a virtual server (e.g., executing on computing hardware), or a server in a cloud computing system. In some implementations, management system 105 includes computing hardware used in a cloud computing environment.

In some implementations, management system 105 may manage a formation of groups of moving objects operating in multiple driving modes. For example, management system 105 may determine a route for an independent moving object. As part of determining the route, management system 105 may identify a group of moving objects (e.g., a platoon) that travels along the route. In this regard, management system 105 may determine a formation for the group of moving objects that may enable the independent moving object to join the group of moving objects, a driving mode of the group of objects, a location for the independent object to join the group of moving objects (also referred to as “joining location”), an estimated time for the independent object to join the group of objects, among other examples.

Management system 105 may determine and provide group information to enable the independent moving object to join the group of moving objects. Management system 105 may provide the group information to a leader moving object. The term “leader moving object” may refer to a moving object that leads the group of moving objects. In some examples, the group information may identify the group of moving objects, a command to adjust the formation for the group of moving objects, the moving object, the location where the moving object may join the group of moving objects, follower moving objects 115 that are to join the group of moving objects, and follower moving objects 115 that are to leave the group of moving objects.

Additionally, or alternatively, the group information may identify a command to reconfigure a formation of the group of moving objects, a location for reconfiguring the formation of the group of moving objects, a driving mode for follower moving objects 115, the estimated time, the group of moving objects, the location where the moving object may leave the group of moving objects, a driving mode for the group of moving objects that are to join the group of moving objects, moving objects that are to leave the group of objects, among other examples.

Management system 105 may determine and provide trip information to enable the independent moving object to join the group of moving objects. Management system 105 may provide the trip information to the independent moving object. In some examples, the trip information may identify the location where the moving object may join the group of moving objects, the estimated time, the driving mode of the group of moving objects, among other examples.

Leader moving object 110 may include a moving object that leads the group of moving objects. Leader moving object 110 may receive the group information from management system 105 and may provide information to follower moving objects 115 to manage a formation of the group of moving objects and manage a driving mode of the group of moving objects. Follower moving objects 115 may include moving objects that are part of the group of moving objects. Follower moving objects 115 may adjust positions and driving modes based on instructions from leader moving object 110. Independent moving object 120 may include a moving object that is part of the group of objects.

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

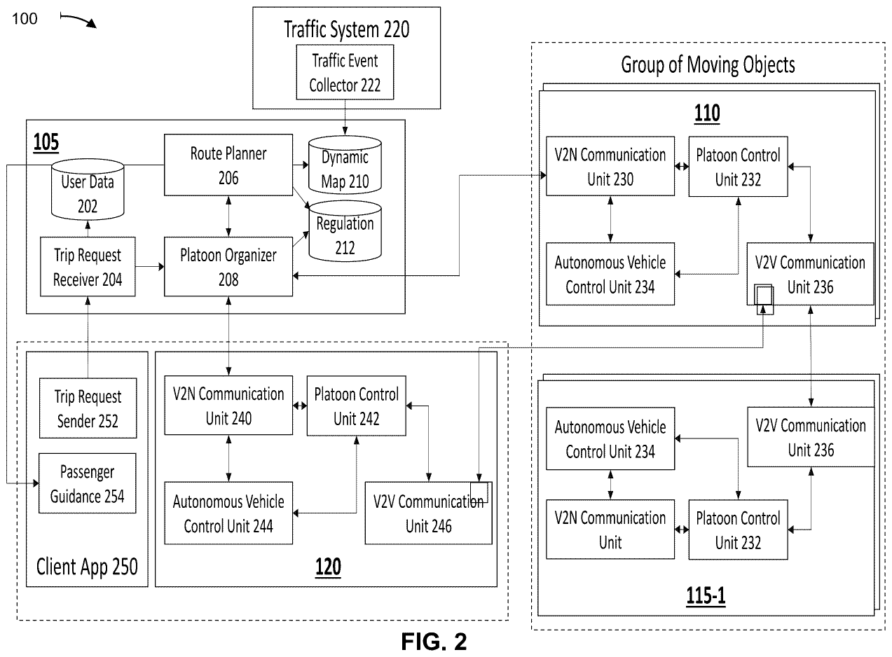

FIG. 2 is a diagram of example components of system 100 described herein. As shown in FIG. 1, system 100 may include management system 105, leader moving object 110, first follower moving object 115-1, independent moving object 120, and a traffic system 220.

As shown in FIG. 2, management system 105 may include a user data 202, a trip request receiver 204, a route planner 206, a platoon organizer 208, a dynamic map 210, and a regulation 212.

User data 202 may include a data store that stores user information regarding users. The data store may be stored on a storage device. The users may include passengers of the group of moving objects, owners of the group of moving objects, among other examples of individuals associated with the group of moving objects. The user information of an individual may identify one or more preferences of the user with respect to travels.

The one or more preferences may identify a preference with respect to speed (e.g., a preference with respect to driving mode), a preference with respect to travel path (e.g., bicycle lanes, road lanes, among other examples), a preference with respect to time of travel (e.g., morning, afternoon, evening), a preference with respect to an amount of travel time, among other examples. In some examples, user data 202 may receive the user information from one or more follower moving objects 115 and/or from independent moving object 120.

Trip request receiver 204 may include one or more devices that receives trip requests from follower moving objects 115 and/or from independent moving object 120. A “trip request” may include a request to determine a route from an origin (or departing location) to a destination. In this regard, the request may include information identifying the origin, the destination, a departure time, an arrival time, a vehicle type (that identifies a type of a moving object submitting the request), a vehicle identifier identifying the moving object, a preference regarding a user associated with the moving object (e.g., a preference regarding a passenger of the moving object), a priority identifying a driving mode.

Route planner 206 may include one or more devices that determine information regarding a route based on the trip route. For example, based on the trip request, management system 105 may identify a route for the trip, a group of moving objects that are traveling along the route and that may be joined by the moving object, a location for joining the group of moving objects, a location for leaving the group of moving objects, a driving mode of the group of moving objects, among other examples. In some situations, route planner 206 may identify multiple groups of moving objects along different locations for joining and leaving each group of moving objects.

Platoon organizer 208 may include one or more devices that determine a formation of the platoon to enable independent moving object 120 to easily join the group of objects. Platoon organizer 208 may determine a driving mode of the group of moving objects to enable independent moving object 120 to easily join the group of moving objects, a location for independent moving objects 120 to join the group of moving objects, and a location for independent moving object 120 to leave the group of moving objects, among other examples.

Platoon organizer 208 may generate group information that identifies the formation, the driving mode, the location for joining the group of objects, the location for leaving the group of moving objects, among other examples. In some implementations, platoon organizer 208 may provide the group information to leader moving object 110.

Dynamic map 210 may include one or more devices that update a map that includes the route based on traffic conditions along the route. In some examples, the traffic conditions may be obtained from traffic system 220.

Regulation 212 may include one or more devices that determine regulations applicable to the route. In some examples, regulation 212 may receive the regulations from different devices of governmental entities and/or municipal entities. The regulations may include speed limits, traffic laws, pedestrian laws, among other examples that govern operations of vehicles along the route.

Traffic system 220 may include one or more devices that determine traffic conditions along a route and provide traffic information regarding the traffic conditions. For example, traffic system 220 may include traffic event collector 222. Traffic event collector 222 may obtain information regarding traffic events along the route. For example, traffic event collector 222 may obtain information regarding accidents, stalled vehicles, disabled vehicles, traffic, among other examples.

In some examples, traffic event collector 222 may obtain the information from moving objects, from vehicles, and/or from roadside units along the route. The roadside units may include various sensor devices, such as camera devices, speed sensor devices, motion detection devices, presence detection devices, among other examples.

As shown in FIG. 2, leader moving object 110 may include a vehicle to network (V2N) communication unit 230, a platoon control unit 232, an autonomous vehicle control unit 234, and a vehicle to vehicle (V2V) communication unit 236.

V2N communication unit 230 may enable leader moving object 110 to communicate with other devices, such as via a wired connection and/or a wireless connection. For example, V2N communication unit 230 may include a receiver, a transmitter, a transceiver, a modem, a network interface card, and/or an antenna. V2N communication unit 230 may be used to communicate with management system 105 (e.g., with platoon organizer 208).

Platoon control unit 232 may obtain the group information from V2N communication unit 230 and provide the group information to follower moving objects 115. The group information may cause follower moving objects to adjust a formation of the group of moving vehicles to enable independent moving object 120 to join the group of moving objects. Additionally, or alternatively, the group information may cause follower moving objects to adjust a driving mode of the group of moving objects to enable independent moving object 120 to leave the group of moving objects.

Autonomous vehicle control unit 234 may include one or more devices that enable leader moving object 110 to operate autonomously. For example, autonomous vehicle control unit 234 may include a control system that makes driving decisions in real time or near real time. For instance, autonomous vehicle control unit 234 may perform control functions for leader moving object 110, such as acceleration, deceleration, steering, among other examples.

V2V communication unit 236 may enable leader moving object 110 to communicate with other devices, such as via a wired connection and/or a wireless connection. For example, V2V communication unit 236 may include a receiver, a transmitter, a transceiver, a modem, a network interface card, and/or an antenna. V2V communication unit 236 may be used to communicate with follower moving object 115 and/or with independent moving object 120.

As shown in FIG. 2, first follower moving object 115-1 may include platoon control unit 232, autonomous vehicle control unit 234, and V2V communication unit 236. As shown in FIG. 2, independent moving object 120 may include a V2N communication unit 240 similar to V2N communication unit 230, a platoon control unit 242 similar to a platoon control unit 232, an autonomous vehicle control unit 244 similar to autonomous vehicle control unit 234, and a V2V communication unit 246 similar to V2V communication unit 236.

As shown in FIG. 2, system 100 may include a client application 250 (also referred to as “client app 250”). In some examples, client app 250 may be included onboard a moving object. Additionally, or alternatively, client app 250 may be included on a device of a passenger (e.g., a mobile device). Client app 250 may include an application that is used to submit a trip request. As shown in FIG. 2, client app 250 may include multiple components, such as a passenger guidance 254 and a trip request sender 252. In some examples, passenger guidance 254 may provide a graphical user interface that provides information regarding a route associated with the trip. For example, passenger guidance 254 may provide a route guidance for the trip (e.g., a turn-by-turn guidance along the route).

Trip request sender 252 may submit trip requests to management system 105. In some implementations, trip request sender 252 may provide a user interface that used to submit information regarding the trip, such as an origin of the trip, a destination of the trip, a departure time of the trip, an arrival time of the trip, a vehicle type (that identifies a type of a moving object submitting the request), a vehicle identifier identifying the moving object, a preference regarding a user associated with the moving object (e.g., a preference regarding a passenger of the moving object), a priority identifying a driving mode, among other examples.

As indicated above, FIG. 2 is provided as an example. Other examples may differ from what is described with regard to FIG. 2 of devices shown in FIG. 2 is provided as an example. There may be additional devices (e.g., a large number of devices), fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices in FIG. 2.

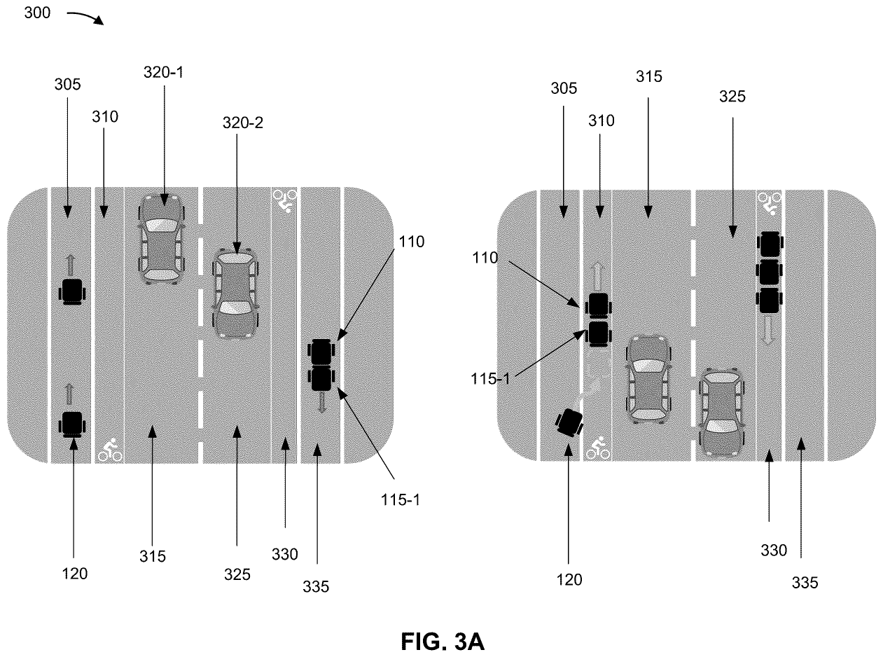

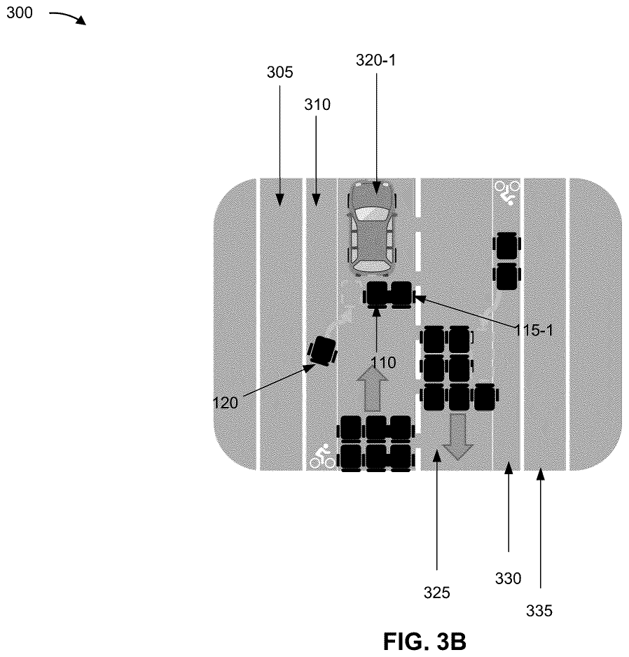

FIGS. 3A and 3B are diagrams of an example implementation 300 described herein. As shown in FIG. 3A, implementation 300 may include leader moving object 110, first follower moving object 115, and independent moving object 120. As shown in FIG. 3A, independent moving object 120 may travel along a first sidewalk 305. In this regard, independent moving object 120 may be traveling in the first driving mode because sidewalks are associated with the first driving mode. A first bicycle lane 310 may be provided next to first sidewalk 305. A first road lane 315 may be provided next to first bicycle lane 310. A first vehicle 320-1 may be traveling along first road lane 315 in a first direction. First sidewalk 305, first bicycle lane 310, and first road lane 315 may form different portions of a travel path.

As shown in FIG. 3A, a second vehicle 320-2 may be traveling along a second road lane 325. A second bicycle lane 330 may be provided next to second road lane 325. A second sidewalk 335 may be provided next to second bicycle lane 330. A second vehicle 320-2 may be traveling along second road lane 325 in a second direction opposite the first direction. Leader moving object 110 and follower moving objects 115 may be traveling along second sidewalk 335. Leader moving object 110 and follower moving objects 115 may form a group of moving objects (e.g., a platoon).

In some examples, leader moving object 110 and follower moving objects 115 may transition to travel on first bicycle lane 310. As shown in FIG. 3A, independent moving object 120 may decide to join the group of moving objects formed by leader moving object 110 and follower moving objects 115 on first bicycle lane 310. Independent moving object 120, leader moving object 110, and follower moving objects 115 may be capable of operating in different driving modes.

A certain number of micromobility vehicles capable of changing to mid-speed mode organize a mid-sized platoon and drive at a mid-speed in a bike lane or on the road edge. Each vehicle complies with the regulation for mid-speed vehicles (e.g., bicycle and motorcycle) including speed limit and legally permitted driving place, as well as switching to the autonomous driving logic for mid-speed mode.

Any vehicles in a platoon of the low-speed mode are allowed to merge into another platoon in the mid-speed mode by changing the driving mode. Similarly, any vehicle in a platoon of the mid-speed mode can drop off the platoon to switch to the low-speed mode.

As shown in FIG. 3B, in some examples, leader moving object 110 and follower moving objects 115 may transition to travel on first road lane 315. In this regard, leader moving object 110 and follower moving objects 115 may be operating in the third driving mode associated with first road lane 315. As shown in FIG. 3B, independent moving object 120 may be traveling in first bicycle lane 310. Accordingly, independent moving object 120 may be traveling in the second driving mode associated with first bicycle lane 310.

As shown in FIG. 3B, independent moving object 120 may decide to join the group of moving objects formed by leader moving object 110 and follower moving objects 115 on first road lane 315. In this regard, independent moving object 120 may transition from operating in the second driving mode to operating in the third driving mode.

Any vehicles in a mid-speed platoon capable of moving to high-speed mode organize a large-sized platoon and drive at a high speed on the driving lane. It is also allowed to organize a platoon with general motor vehicles being equipped with just a high-speed mode. Any vehicle in a mid-speed platoon can transfer to a high-speed platoon. Similarly, any vehicles in a high-speed platoon can move to any mid-or low-speed platoon.

As indicated above, FIGS. 3A and 3B are provided as an example. Other examples may differ from what is described with regard to FIGS. 3A and 3B of devices shown in FIGS. 3A and 3B are provided as an example. There may be additional devices (e.g., a large number of devices), fewer devices, different devices, or differently arranged devices than those shown in FIGS. 3A and 3B. Furthermore, two or more devices shown in FIGS. 3A and 3B may be implemented within a single device, or a single device shown in FIGS. 3A and 3B may be implemented as multiple, distributed devices. Additionally, or alternatively, a set of devices (e.g., one or more devices) shown in FIGS. 3A and 3B may perform one or more functions described as being performed by another set of devices shown in FIGS. 3A and 3B.

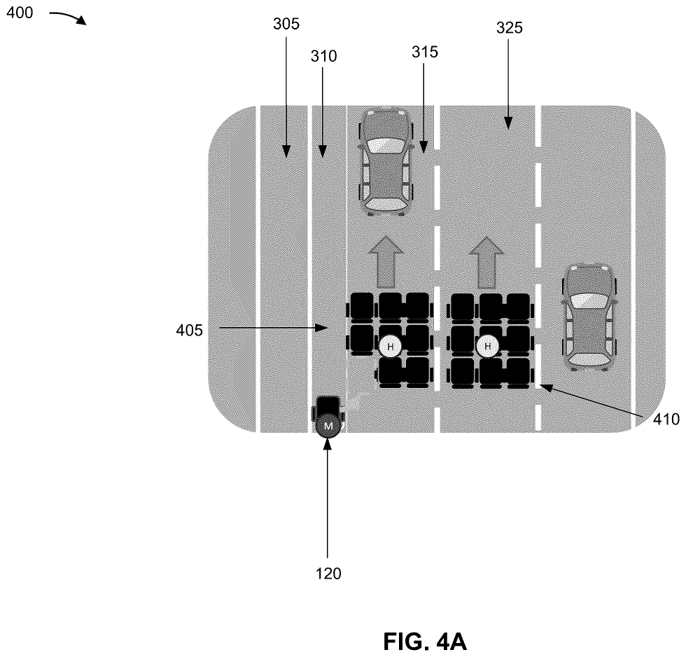

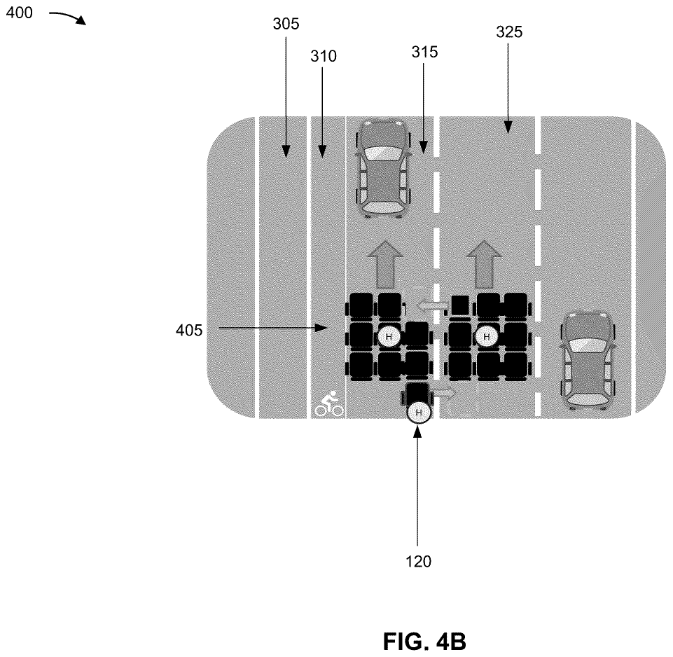

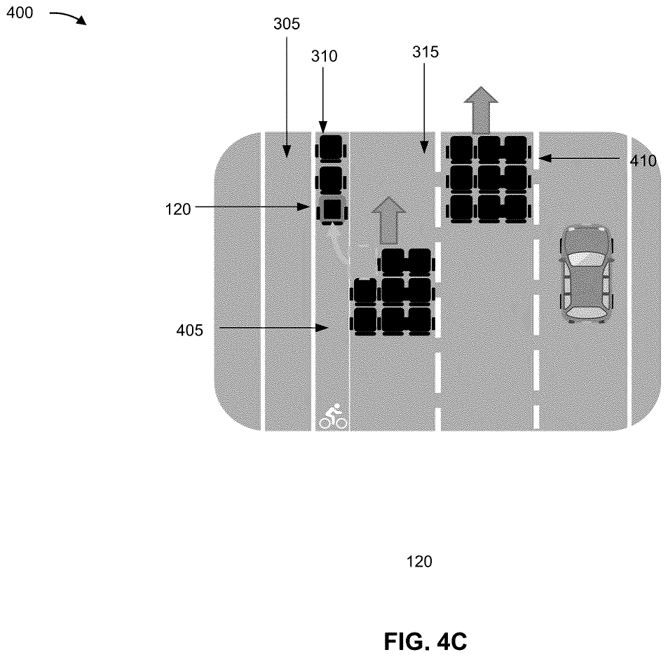

FIGS. 4A-4C are diagrams of an example implementation 400 described herein. As shown in FIG. 4A, implementation 400 may include independent moving object 120 and additional moving objects. As shown in FIG. 4A, a first group 405 of moving objects may be traveling on first road lane 315. As shown in FIG. 4A, a second group 410 of moving objects may be traveling on second road lane (road) 325. Independent moving object 120 may be traveling on first bicycle lane 310. As shown in FIG. 4A, independent moving object 120 may decide to join first group 405 of moving objects. In this regard, independent moving object 120 may transition from operating in the second driving mode to operating in the third driving mode.

A vehicle of mid-speed platoon can be merged into a high-speed platoon running on the 1^{st} lane (first road lane 315) by switching its driving mode, but may not be merged into a platoon on 2^{nd} lane (second road lane 325) directly. After a mid-speed vehicle merged into a high-speed platoon running on the 1^{st} lane, the platoons on the 1^{st} and 2^{nd} lanes are running in parallel temporarily.

As shown in FIG. 4B, independent moving object 120 may decide to join second group 410 of moving objects. Additionally, a moving object from second group 410 of moving objects may decide to join first group 405 of moving objects.

A vehicle, which will be changed to a high-speed mode from a mid-speed mode, merges into the platoon in the 1^{st} lane. For a time being, the vehicle that plans to run in a high-speed mode merge into the platoon on 2^{nd} lane. For smooth vehicle exchange, a vehicle position may change in advance. For example, for a vehicle moving from 2^{nd} lane to 1^{st} lane, the vehicle may move to position, in the first lane, that is closer to the 2^{nd} lane.

As shown in FIG. 4C, independent moving object 120 may be traveling with first group 405 of moving objects. At some period in time, as shown in FIG. 4C, independent moving object 120 may decide to exit first group 405 of moving objects and travel independently of a group of moving objects on first bicycle lane 310. In this regard, independent moving object 120 may transition from operating in the third driving mode to operating in the second driving mode.

As indicated above, FIGS. 4A-4C are provided as an example. Other examples may differ from what is described with regard to FIGS. 4A-4C of devices shown in FIGS. 4A-4C are provided as an example. There may be additional devices (e.g., a large number of devices), fewer devices, different devices, or differently arranged devices than those shown in FIGS. 4A-4C. Furthermore, two or more devices shown in FIGS. 4A-4C may be implemented within a single device, or a single device shown in FIGS. 4A-4C may be implemented as multiple, distributed devices. Additionally, or alternatively, a set of devices (e.g., one or more devices) shown in FIGS. 4A-4C may perform one or more functions described as being performed by another set of devices shown in FIGS. 4A-4C.

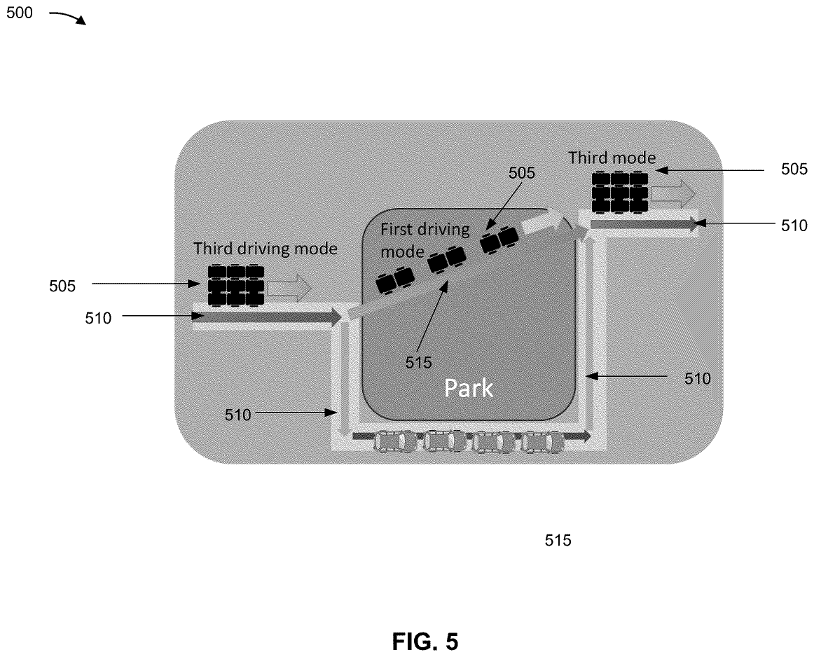

FIG. 5 are diagrams of an example implementation 500 described herein. As shown in FIG. 3A, implementation 500 may include a group 505 of moving objects. As shown in FIG. 5, group 505 of moving objects may be traveling along an initial route 510 towards a destination. Group 505 of moving objects may be operating under the third driving mode.

As shown in FIG. 5, a portion of initial route 510 may be experiencing traffic congestion. Based on traffic congestion, management system 105 and/or a leader moving object of group 505 of moving objects may identify an alternate route 515 to avoid the traffic congestion. As shown in FIG. 5, alternate route 515 may include a park. The park may be associated with the first driving mode. In this regard, group 505 of moving objects may change a formation from 3×2 to 1×6 travel along the alternate route (e.g., through the park). Additionally, because of the park may be associated with the first driving mode, group 505 of moving objects may transition from operating in the third driving mode to operating in the first driving mode.

At the same time the mode is switched, regulations (speed limit, travel division, etc.), and autonomous driving logics (sign recognition, obstacle avoiding algorithm, etc.) are changed into the logics for the low-speed mode. As shown in FIG. 5, group 505 of moving objects may return to traveling on initial route 510. By transitioning back to initial route 510, group 505 of moving objects may transition to operating under the third driving mode.

As indicated above, FIG. 5 is provided as an example. Other examples may differ from what is described with regard to FIG. 5 of devices shown in FIG. 5 is provided as an example. There may be additional devices (e.g., a large number of devices), fewer devices, different devices, or differently arranged devices than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) shown in FIG. 5 may perform one or more functions described as being performed by another set of devices in FIG. 5.

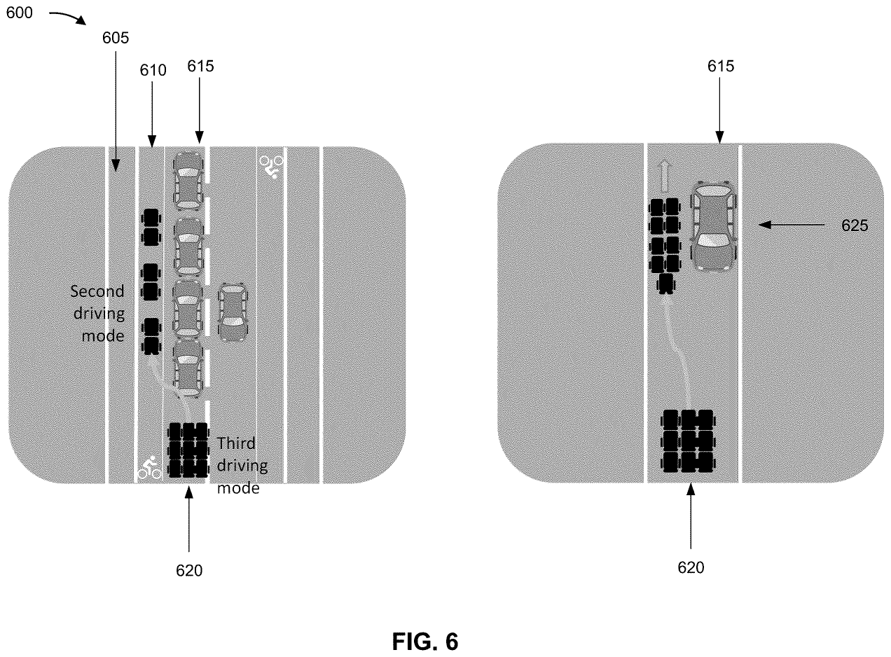

FIG. 6 are diagrams of an example implementation 600 described herein. As shown in FIG. 6, implementation 600 may include a group 620 of moving objects. As shown in FIG. 6, group 620 of moving objects may be traveling along road 615 towards a destination. Group 620 of moving objects may be operating under the third driving mode.

Management system 105 and/or one or more moving objects may detect traffic congestion along road 615. Based on traffic congestion, management system 105 and/or a leader moving object of group 620 of moving objects may identify an alternate route to avoid the traffic congestion. As shown in FIG. 6, the alternate route may include a sidewalk 605 or a bicycle lane 610. Management system 105 may select bicycle lane 610 because group 620 of moving objects may operate at a speed that exceeds a speed associated with sidewalk 605. In this regard, group 620 of moving objects may change a formation from 3×to 1×6 travel along the alternate route (e.g., through the park). Additionally, because of bicycle lane 610 may be associated with the second driving mode, group 620 of moving objects may transition from operating in the third driving mode to operating in the second driving mode.

To avoid a traffic jam, management system 105 may select a route on a bicycle lane in mid-speed mode with breaking the platoon into small platoons. At the same time the mode is switched, regulations and autonomous driving logics are changed into the logics for the mid-speed mode. To pass an oncoming car 625 at a narrow point, management system 105 may change the platoon formation dynamically. Based on the new formation (platoon length, width, etc.), autonomous driving logics are changed.

As indicated above, FIG. 6 is provided as an example. Other examples may differ from what is described with regard to FIG. 6 of devices shown in FIG. 6 is provided as an example. There may be additional devices (e.g., a large number of devices), fewer devices, different devices, or differently arranged devices than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) shown in FIG. 6 may perform one or more functions described as being performed by another set of devices in FIG. 6.

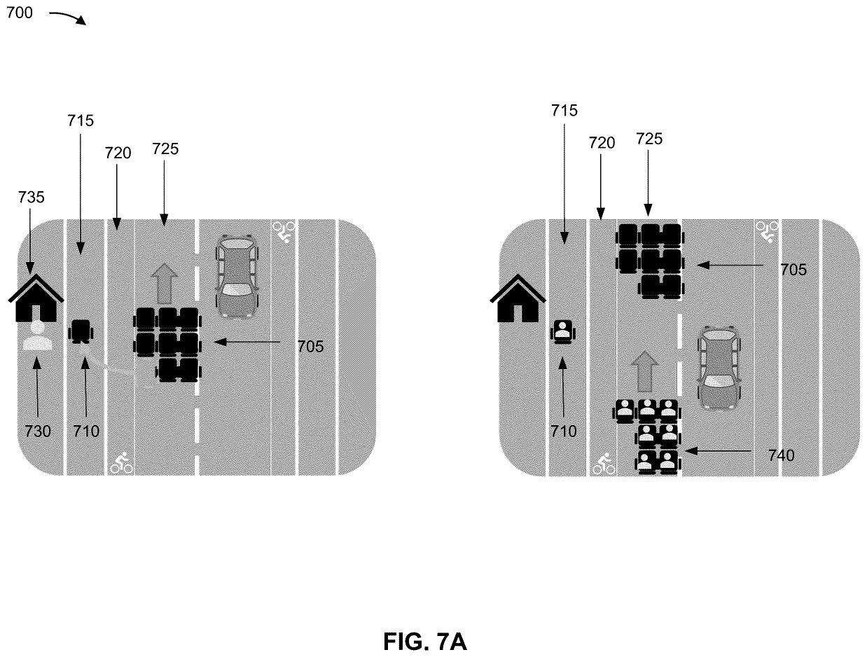

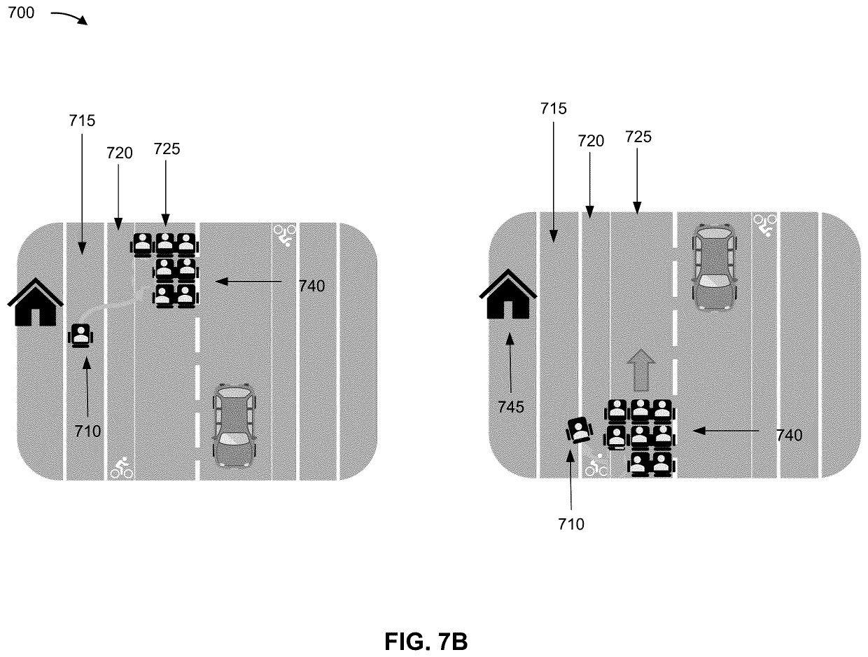

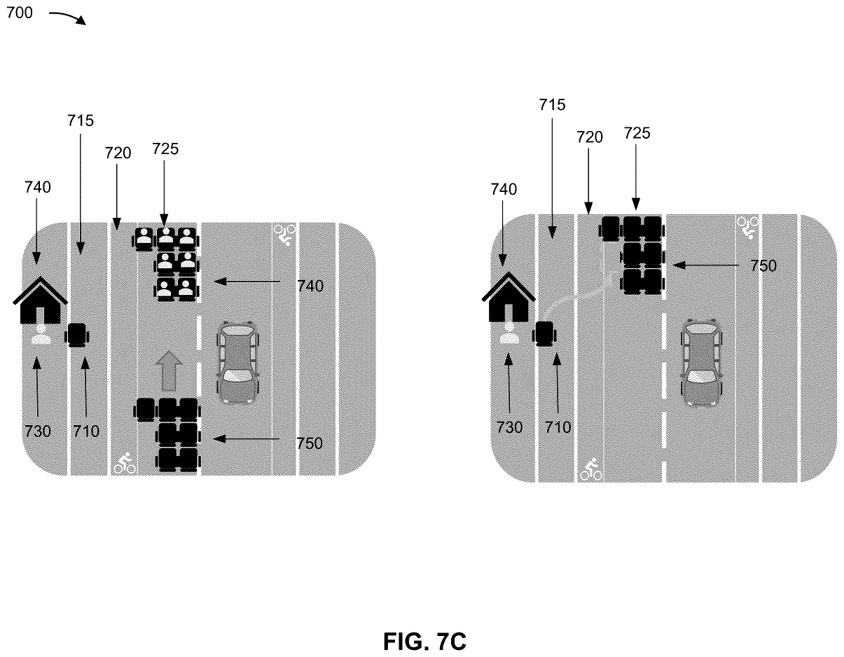

FIGS. 7A-7C are diagrams of an example implementation 700 described herein. As shown in FIG. 7A, implementation 700 may include a first group 705 of moving objects and a transportation moving object 710. As shown in FIG. 7A, transportation moving object 710 may leave first group 705 of moving objects to travel on sidewalk 715 while first group 705 of moving objects continues to travel on a road lane 725. A bicycle lane 720 may be provided between sidewalk 715 and road lane 725.

As shown in FIG. 7A, transportation moving object 710 may leave first group 705 to pick up a passenger 730 at a pick up location 735. Pick up location 735 may include a home, an office, a location for lodging, among other examples. First group 705 may be formed by empty vehicles and may deliver transportation moving object 710 at pick up location 735.

As shown in FIG. 7A, passenger 730 may onboard transportation moving object 710. After passenger 730 onboards, transportation moving object 710, transportation moving object 710 may wait for a second group 740 of moving objects. Second group 740 of moving objects may include a transporting platoon formed by vehicles with passengers. Transportation moving object 710 may travel along sidewalk 715 until second group 740 of moving objects arrives at pick up location 735.

As shown in FIG. 7B, transportation moving object 710 may join second group 740 of moving objects at pick up location 735. As shown in FIG. 7B, as second group 740 of moving objects approaches a drop location 745, transportation moving object 710 may leave second group 740 of moving objects to prepare to drop off passenger 730 at drop off location 745. For example, when second group 740 of moving objects is approaching drop off location 745, transportation moving object 710 may leave second group 740 of moving objects.

As shown in FIG. 7C, transportation moving object 710 has dropped off passenger 730. After passenger 730 deboards transportation moving object 710, transportation moving object 710 may wait for a third group 750 of moving objects. Third group 750 of moving objects may include a repositioning platoon.

As shown in FIG. 7C, transportation moving object 710 may join third group 750 of moving objects. Transportation moving object 710 may move to another reservation point or a maintenance facility. As shown in FIG. 7C, transportation moving object 710 may transition from a road lane to a bike lane and, accordingly, transition from the third driving mode to the second driving mode. Transportation moving object 710 may transition from a bike lane to a sidewalk and, accordingly, transition from the second driving mode to the first driving mode. Transportation moving object 710 may transition from the road lane to the sidewalk and, accordingly, transition from the third driving mode to the first driving mode if no vehicles are provided in the bike lane.

As indicated above, FIGS. 7A-7C are provided as an example. Other examples may differ from what is described with regard to FIGS. 7A-7C of devices shown in FIGS. 7A-7C are provided as an example. There may be additional devices (e.g., a large number of devices), fewer devices, different devices, or differently arranged devices than those shown in FIGS. 7A-7C. Furthermore, two or more devices shown in FIGS. 7A-7C may be implemented within a single device, or a single device shown in FIGS. 7A-7C may be implemented as multiple, distributed devices. Additionally, or alternatively, a set of devices (e.g., one or more devices) shown in FIGS. 7A-7C may perform one or more functions described as being performed by another set of devices shown in FIGS. 7A-7C.

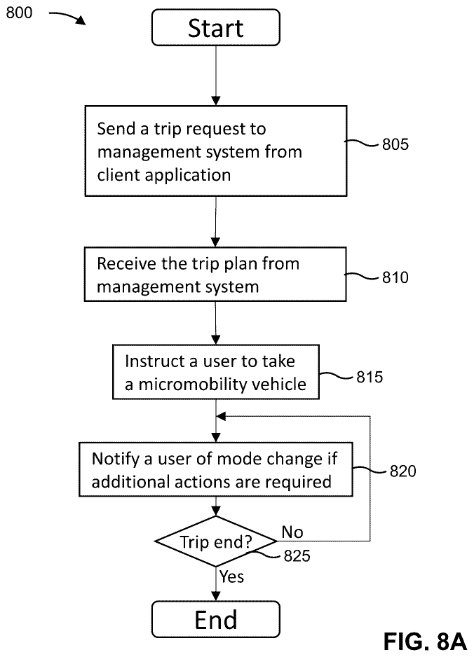

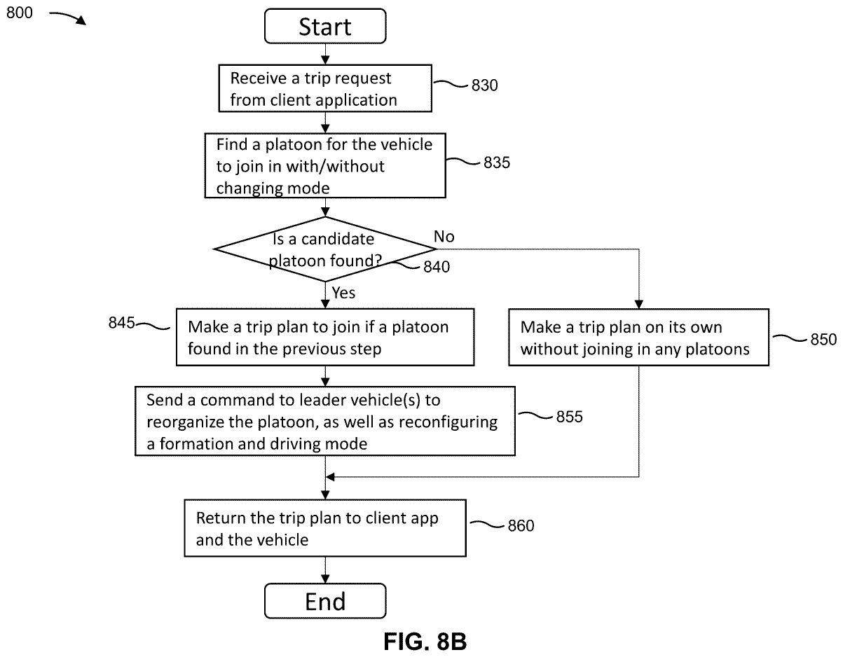

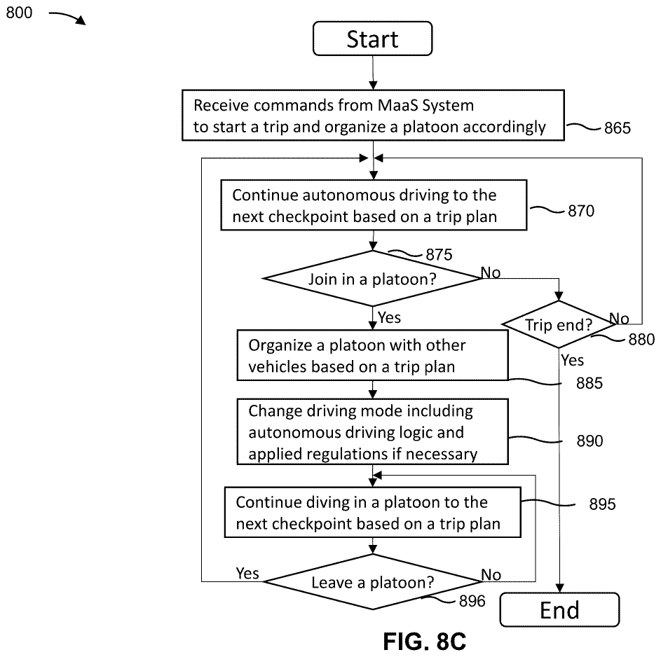

FIGS. 8A-8C are flowcharts of an example process 800 associated with organizing movement of autonomous vehicles described herein. As shown in FIG. 8A, process 800 may include sending a trip request to management system 105 from client application (block 805). For example, independent moving object 120 may send a trip request (for a trip) using client app 250. The trip request may include information identifying a user (e.g., a passenger), an origin of the trip, a destination of the trip, a departure time for the trip, an arrival time for the trip, a vehicle type of independent moving object 120, a vehicle identifier of independent moving object 120, and a preference regarding the trip. The vehicle type may indicate whether independent moving object 120 is owned or is rented.

In some examples, vehicle data (regarding independent moving object 120) can be embedded in the trip request or can be externally referred to. This is optional when hiring a public vehicle. In some examples, the vehicle data may identify the vehicle identifier, a type, capabilities of the vehicle. The type may indicate whether independent moving object 120 is micromobility vehicle. The capabilities may indicate driving modes supported by independent moving object 120 and a capacity of independent moving object 120. The capacity may indicate a number of passengers that can be transported by independent moving object 120.

As shown in FIG. 8A, process 800 may include receiving a trip plan from management system 105. For example, independent moving object 120 may receive the trip plan from management system 105 (block 810). The trip plan may include information about when to start and where to reorganize the group of moving objects. Management system 105 may determine the trip plan based on the trip request. The trip plan may identify a trip identifier, the origin, the destination, the departure time, the arrival time, the vehicle identifier, and the route. The route may identify the group of moving objects, a joining location for independent moving object 120 to join the group of moving objects, an exit location for independent moving object 120 to leave the group of moving objects, a driving mode of the group of moving objects, among other examples.

As shown in FIG. 8A, process 800 may include instructing a user to take a micromobility vehicle (block 815). For example, independent moving object 120 may instruct a passenger to onboard independent moving object 120.

As shown in FIG. 8A, process 800 may include notifying a user of mode change if additional actions are required (block 820). For example, independent moving object 120 may instruct a passenger to onboard independent moving object 120.

As shown in FIG. 8A, process 800 may include determining if the trip has ended (block 825). For example, if the trip has not ended, independent moving object 120 may proceed again with notifying the user of a change in driving mode if additional actions are required.

As shown in FIG. 8B, process 800 may include receiving a trip request from a client application (block 830). For example, management system 105 may receive a trip request from independent moving object 120 via client app 250.

As shown in FIG. 8B, process 800 may include finding a platoon for independent moving object 120 to join with or without changing a driving mode (block 835). For example, management system 105 may find a platoon that independent moving object 120 may join. The platoon may be a platoon that may cause independent moving object 120 to change a driving mode of operation.

As shown in FIG. 8B, process 800 may include determining whether a candidate platoon has been found (block 840). For example, management system 105 may determine whether a group of moving objects traveling, along the route of the trip, has been found. Management system 105 may identify a group of moving objects traveling, along the route of the trip, based on information included in the trip request. In some examples, based on the information included in the trip request, management system 105 may determine whether the group of moving objects is operating in accordance with the preference (described herein) of the passenger.

As shown in FIG. 8B, process 800 may include making a trip plan to join the platoon if the platoon is found (block 845). For example, management system 105 may generate a trip plan for independent moving object 120 to join the platoon if the platoon is found.

As shown in FIG. 8B, process 800 may include making a trip plan without joining a platoon if the platoon is not found (block 850). For example, management system 105 may generate a trip plan without joining a platoon if the platoon is not found.

As shown in FIG. 8B, process 800 may include sending a command to leader vehicle(s) to reorganize the platoon, as well as reconfiguring a formation and a driving mode (block 855). For example, management system 105 may send a command to one or more leader vehicles (of one or more platoons) to reorganize the one or more platoons. With respect to reorganizing a platoon, the command may instruct leader vehicle to add one or more new vehicles to a platoon and/or drop one or more existing vehicles from the platoon. As an example, the command may include information identifying the platoon, the command as a command to reorganize the platoon, a location for adding vehicles, the vehicles to be added, a location for dropping vehicles, a location for dropping the vehicles, among other examples. Additionally, or alternatively, the command may cause the one or more leader vehicles to reconfigure a formation and a driving mode of the one or more platoons. As an example, the command may include information identifying the platoon, the command as a command to reconfigure the platoon, a location for reconfiguring the platoon, a driving mode for the platoon, a formation of the platoon (e.g., a quantity of rows of vehicles and a quantity of vehicles per row).

As shown in FIG. 8B, process 800 may include returning the trip plan to the client application and the vehicle (block 860). For example, management system 105 may return the trip plan to client app 250 and to independent moving object 120. In some examples, the trip plan may include the information described in connection with block 810.

As shown in FIG. 8C, process 800 may include receiving commands from a MaaS System to start a trip and organize a platoon accordingly (block 865). For example, independent moving object 120 may receive commands from management system 105 to start a trip and organize a platoon, based on sending the trip request. In some examples, the commands may be received as part of a trip plan (also referred to as group information). In some examples, the trip plan may instruct a vehicle to join in the platoon based on the command, along with a merging location. In some situations, detail of the platoon may be embedded in the command or may be included in a separate data structure provided to independent moving object 120. The group information may identify independent moving object 120, a command (e.g., to merge with or join the platoon), a location for joining the platoon, the platoon. In some situation, the information identifying the platoon may identify a current location of the platoon, leader moving object 110, a driving mode of the platoon, a number of moving objects included in the platoon, among other examples.

As shown in FIG. 8C, process 800 may include continuing autonomous driving to the next checkpoint based on a trip plan (block 870). For example, independent moving object 120 may continue autonomous driving to a location (e.g., the next checkpoint) identified by the trip plan.

As shown in FIG. 8C, process 800 may include determining whether to join a platoon (block 875). For example, independent moving object 120 may determine whether to the trip plan instructs independent moving object 120 to join a platoon at the next checkpoint.

As shown in FIG. 8C, process 800 may include determining whether the trip has ended (block 880). For example, independent moving object 120 may determine whether the trip has ended by determining whether the platoon has arrived at the destination identified by the trip plan. If independent moving object 120 determines that the trip has not ended, independent moving object 120 may continue autonomous driving to another checkpoint identified by the trip plan (as described in connection with block 870). If independent moving object 120 determines that the trip has ended, process 800 may end.

As shown in FIG. 8C, process 800 may include organizing a platoon with other vehicles based on a trip plan (block 885). For example, based on the trip plan, independent moving object 120 may organize or form a platoon at the next checkpoint or may join a platoon at the next checkpoint. In some examples, the trip plan may identify the platoon.

As shown in FIG. 8C, process 800 may include changing driving mode including autonomous driving logic and applied regulations if necessary (block 890). For example, the trip plan may instruct independent moving object 120 to change a current driving mode to a new driving mode of the platoon. Additionally, the trip plan may include information regarding applicable regulations of the platoon.

As shown in FIG. 8C, process 800 may include continue driving in a platoon to a next checkpoint based on a trip plan (block 895). For example, based on the trip plan, independent moving object 120 may continue diving in the platoon to a next checkpoint.

As shown in FIG. 8C, process 800 may include determining whether to leave the platoon (block 896). For example, independent moving object 120 may determine whether to leave the platoon. If independent moving object 120 determines to leave the platoon, independent moving object 120 may continue autonomous driving to another checkpoint identified by the trip plan (as described in connection with block 870). If independent moving object 120 determines to not leave the platoon, independent moving object 120 may continue diving with the platoon to a next checkpoint.

As indicated above, FIGS. 8A-8C are provided as an example. Other examples may differ from what is described with regard to FIGS. 8A-8C of devices shown in FIGS. 8A-8C are provided as an example. There may be additional devices (e.g., a large number of devices), fewer devices, different devices, or differently arranged devices than those shown in FIGS. 8A-8C. Furthermore, two or more devices shown in FIGS. 8A-8C may be implemented within a single device, or a single device shown in FIGS. 8A-8C may be implemented as multiple, distributed devices. Additionally, or alternatively, a set of devices (e.g., one or more devices) shown in FIGS. 8A-8C may perform one or more functions described as being performed by another set of devices shown in FIGS. 8A-8C.

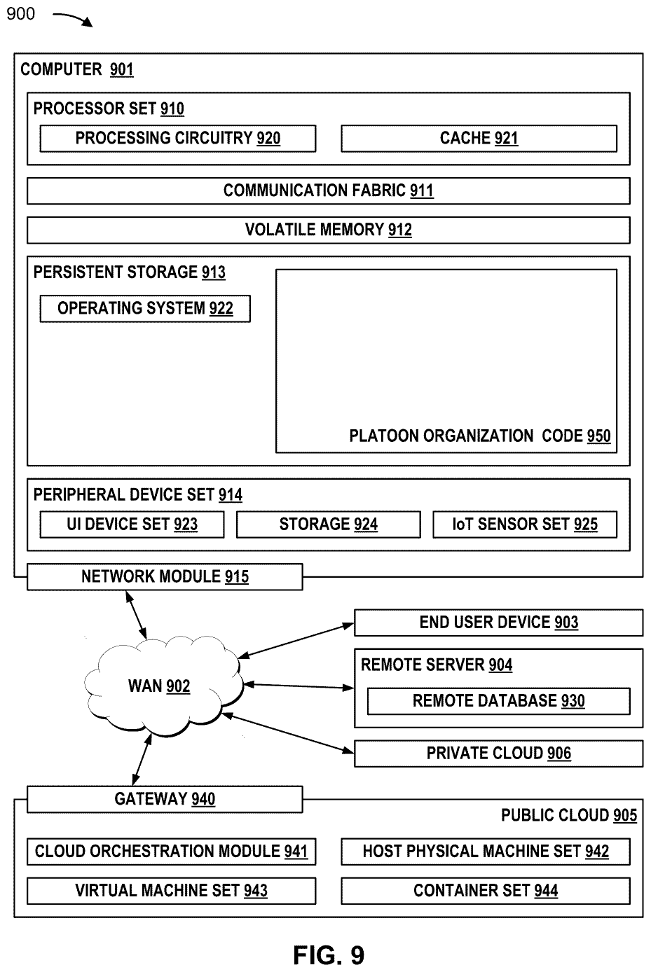

FIG. 9 is a diagram of an example computing environment 900 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code involved in performing the inventive methods, such as platoon organization code 950. In addition to block 950, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 950, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 950 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in block 950 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901) and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computational resources of public cloud 905 is performed by the computer hardware and/or software of cloud orchestration module 941. The computational resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computational resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

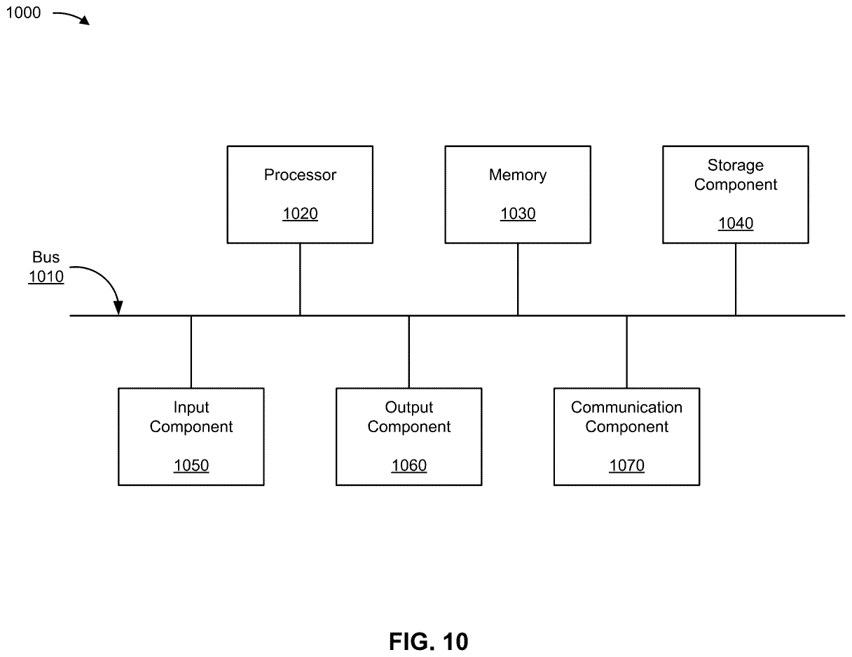

FIG. 10 is a diagram of example components of a device 1000, which may correspond to management system 105. In some implementations, management system 105 may include one or more devices 1000 and/or one or more components of device 1000. As shown in FIG. 10, device 1000 may include a bus 1010, a processor 1020, a memory 1030, a storage component 1040, an input component 1050, an output component 1060, and a communication component 1070.

Bus 1010 includes a component that enables wired and/or wireless communication among the components of device 1000. Processor 1020 includes a central processing unit, a graphics processing unit, a microprocessor, a controller, a microcontroller, a digital signal processor, a field-programmable gate array, an application-specific integrated circuit, and/or another type of processing component. Processor 1020 is implemented in hardware, firmware, or a combination of hardware and software. In some implementations, processor 1020 includes one or more processors capable of being programmed to perform a function. Memory 1030 includes a random access memory, a read only memory, and/or another type of memory (e.g., a flash memory, a magnetic memory, and/or an optical memory).

Storage component 1040 stores information and/or software related to the operation of device 1000. For example, storage component 1040 may include a hard disk drive, a magnetic disk drive, an optical disk drive, a solid state disk drive, a compact disc, a digital versatile disc, and/or another type of non-transitory computer-readable medium. Input component 1050 enables device 1000 to receive input, such as user input and/or sensed inputs. For example, input component 1050 may include a touch screen, a keyboard, a keypad, a mouse, a button, a microphone, a switch, a sensor, a global positioning system component, an accelerometer, a gyroscope, and/or an actuator. Output component 1060 enables device 1000 to provide output, such as via a display, a speaker, and/or one or more light-emitting diodes. Communication component 1070 enables device 1000 to communicate with other devices, such as via a wired connection and/or a wireless connection. For example, communication component 1070 may include a receiver, a transmitter, a transceiver, a modem, a network interface card, and/or an antenna.

Device 1000 may perform one or more processes described herein. For example, a non-transitory computer-readable medium (e.g., memory 1030 and/or storage component 1040) may store a set of instructions (e.g., one or more instructions, code, software code, and/or program code) for execution by processor 1020. Processor 1020 may execute the set of instructions to perform one or more processes described herein. In some implementations, execution of the set of instructions, by one or more processors 1020, causes the one or more processors 1020 and/or the device 1000 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 10 are provided as an example. Device 1000 may include additional components, fewer components, different components, or differently arranged components than those shown in FIG. 10. Additionally, or alternatively, a set of components (e.g., one or more components) of device 1000 may perform one or more functions described as being performed by another set of components of device 1000.

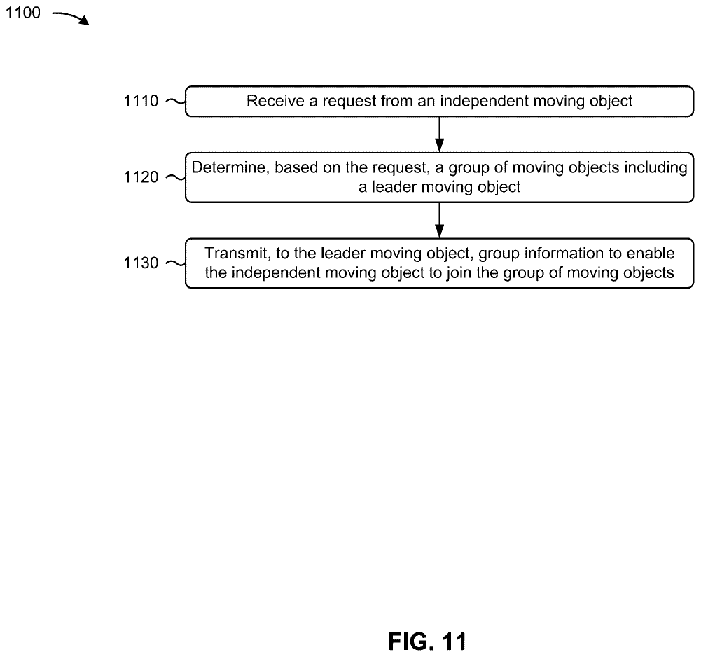

FIG. 11 is a flowchart of an example process 1100 associated with organizing movement of autonomous vehicles. In some implementations, one or more process blocks of FIG. 11 may be performed by a management system (e.g., management system 105). In some implementations, one or more process blocks of FIG. 11 may be performed by another device or a group of devices separate from or including the management system, such as leader moving object (e.g., leader moving object 110) and/or independent moving object (e.g., independent moving object 120). Additionally, or alternatively, one or more process blocks of FIG. 11 may be performed by one or more components of device 1000, such as processor 1020, memory 1030, storage component 1040, input component 1050, output component 1060, and/or communication component 1070.

As shown in FIG. 11, process 1100 may include receiving a request from an independent moving object (block 1110). For example, the management system may receive a request from an independent moving object, as described above.

As further shown in FIG. 11, process 1100 may include determining, based on the request, a group of moving objects including a leader moving object (block 1120). For example, the management system may determine, based on the request, a group of moving objects including a leader moving object, as described above.

As further shown in FIG. 11, process 1100 may include transmitting, to the leader moving object, group information to enable the independent moving object to join the group of moving objects (block 1130). For example, the management system may transmit, to the leader moving object, group information to enable the independent moving object to join the group of moving objects, as described above.

In some implementations, each of the independent moving object and the leader moving object is a vehicle, the request includes a trip request indicating at least one of an origin of the independent moving object, a destination of the independent moving object, and a speed of the independent moving object, and determining the group of moving objects based on the request comprises determining the group of moving objects based on the one of the origin, the destination, and the speed.

In some implementations, the group information includes information used to reorganize the group of moving objects and to reconfigure a formation of moving objects and a driving mode of moving objects.

In some implementations, process 1100 includes transmitting, to the independent moving object, trip information to enable the independent moving object to join the group of moving objects, the trip information identifies a speed of the group of moving objects and identifies a route traveled by the group of moving objects, and the trip information is transmitted to cause the independent moving object to travel with the group of moving objects.

In some implementations, transmitting the trip information to the independent moving object comprises transmitting the trip information to cause the independent moving object to adjust the speed of the independent moving object to the speed of the group of moving objects, wherein the speed of the individual moving object is adjusted to enable the independent moving object to travel with the group of moving objects.

In some implementations, the speed of the independent moving object is a speed associated with the first portion of the path, the speed of the group of moving objects is a speed associated with the first portion of the travel path, and transmitting the trip information to the independent moving object comprises transmitting the trip information to cause the independent moving object to travel at the speed associated with the second portion of the traveling path. In some implementations, prior to transmitting the group information, the independent moving object may be traveling on a first portion of a traveling path and the group of moving objects are traveling on a second portion of the traveling path.

In some implementations, the first portion of the traveling path includes a sidewalk or a bicycle lane, and wherein the second portion of the traveling path includes a roadway.

In some implementations, the request includes a trip request indicating at least one of a selected departure time of the independent moving object, a selected arrival time of the independent moving object, and a capability of the independent moving object, and determining the group of moving objects based on the request comprises determining the group of moving objects based on the one of the selected departure time, the selected arrival time, or the capability of the independent moving object.

In some implementations, process 1100 includes determining driving conditions associated with the group of moving objects driving, causing a formation of the group of moving objects to be adjusted based on the driving conditions, and adjusting a speed of the group of moving objects to be adjusted based on the driving conditions.

In some implementations, process 1100 includes determining a position for the independent moving object in a formation of the group of moving objects, wherein the group information includes information identifying the position for the independent moving object.

Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
receiving a request from an independent moving object;
determining, based on the request, a group of moving objects including a leader moving object; and
transmitting, to the leader moving object, group information to enable the independent moving object to join the group of moving objects.

2. The computer-implemented method of claim 1, wherein each of the independent moving object and the leader moving object is a vehicle,
wherein the request includes a trip request indicating at least one of an origin of the independent moving object, a destination of the independent moving object, and a speed of the independent moving object, and
wherein determining the group of moving objects based on the request comprises determining the group of moving objects based on the least one of the origin, the destination, and the speed.

3. The computer-implemented method of claim 2, wherein the group information includes information used to reorganize the group of moving objects and to reconfigure a formation of moving objects and a driving mode of moving objects.

4. The computer-implemented method of claim 2, further comprising:
transmitting, to the independent moving object, trip information to enable the independent moving object to join the group of moving objects,
wherein the trip information identifies a speed of the group of moving objects and identifies a route traveled by the group of moving objects, and
wherein the trip information is transmitted to cause the independent moving object to travel with the group of moving objects.

5. The computer-implemented method of claim 4, wherein transmitting the trip information to the independent moving object comprises:
transmitting the trip information to cause the independent moving object to adjust the speed of the independent moving object to the speed of the group of moving objects,
wherein the speed of the independent moving object is adjusted to enable the independent moving object to travel with the group of moving objects.

6. The computer-implemented method of claim 4, wherein, prior to transmitting the group information, the independent moving object is traveling on a first portion of a traveling path and the group of moving objects are traveling on a second portion of the traveling path,
wherein the speed of the independent moving object is a speed associated with the first portion of the path,
wherein the speed of the group of moving objects is a speed associated with the first portion of the travel path, and
wherein transmitting the trip information to the independent moving object comprises:
transmitting the trip information to cause the independent moving object to travel at the speed associated with the second portion of the traveling path.

7. The computer-implemented method of claim 6, wherein the first portion of the traveling path includes a sidewalk or a bicycle lane, and
wherein the second portion of the traveling path includes a roadway.

8. The computer-implemented method of claim 2, wherein the request includes a trip request indicating at least one of a selected departure time of the independent moving object, a selected arrival time of the independent moving object, and a capability of the independent moving object, and
wherein determining the group of moving objects based on the request comprises determining the group of moving objects based on the at least one of the selected departure time, the selected arrival time, or the capability of the independent moving object.

9. The computer-implemented method of claim 1, further comprising:
determining driving conditions associated with the group of moving objects;
causing a formation of the group of moving objects to be adjusted based on the driving conditions; and
adjusting a speed of the group of moving objects to be adjusted based on the driving conditions.

10. The computer-implemented method of claim 1, further comprising:
determining a position for the independent moving object in a formation of the group of moving objects,
wherein the group information includes information identifying the position for the independent moving object.

11. A management system, comprising:
one or more memories; and
one or more processors, coupled to the one or more memories, configured to:
receive a request from an independent moving object;
determine, based on the request, a group of moving objects including a leader moving object; and
transmit, to the leader moving object, group information to enable the independent moving object to join the group of moving objects.

12. The management system of claim 11, wherein each of the independent moving object and the leader moving object is a vehicle,
wherein the request includes a trip request indicating at least one of an origin of the independent moving object, a destination of the independent moving object, and a speed of the independent moving object, and
wherein the one or more processors, to determine the group of moving objects based on the request, are configured to determine the group of moving objects based on the at least one of the origin, the destination, and the speed.

13. The management system of claim 12, wherein the group information includes information used to reorganize the group of moving objects and to reconfigure a formation of moving objects and a driving mode of moving objects.

14. The management system of claim 12, wherein the one or more processors are further configured to:
transmit, to the independent moving object, trip information to enable the independent moving object to join the group of moving objects,
wherein the trip information identifies a speed of the group of moving objects and identifies a route traveled by the group of moving objects, and
wherein the trip information is transmitted to cause the independent moving object to travel with the group of moving objects.

15. The management system of claim 14, wherein the one or more processors, to transmit the trip information to the independent moving object, are configured to:
transmit the trip information to cause the independent moving object to adjust the speed of the independent moving object to the speed of the group of moving objects,
wherein the speed of the independent moving object is adjusted to enable the independent moving object to travel with the group of moving objects.

16. A non-transitory computer-readable medium storing a set of instructions, the set of instructions comprising:
one or more instructions that, when executed by one or more processors of a management system, cause the management system to:
receive a request from an independent moving object;
determine, based on the request, a group of moving objects including a leader moving object; and
transmit, to the leader moving object, group information to enable the independent moving object to join the group of moving objects.

17. The non-transitory computer-readable medium of claim 16, wherein each of the independent moving object and the leader moving object is a vehicle,
wherein the request includes a trip request indicating at least one of an origin of the independent moving object, a destination of the independent moving object, and a speed of the independent moving object, and
wherein the one or more instructions, that cause the management system to determine the group of moving objects based on the request, cause the management system to determine the group of moving objects based on the at least one of the origin, the destination, and the speed.

18. The non-transitory computer-readable medium of claim 16, wherein the one or more instructions further cause the management system to:
transmit, to the independent moving object, trip information to enable the independent moving object to join the group of moving objects,
wherein the trip information identifies a speed of the group of moving objects and identifies a route traveled by the group of moving objects, and
wherein the one or more instructions further cause the management system to travel with the group of moving objects.

19. The non-transitory computer-readable medium of claim 18, wherein the one or more instructions, that cause the management system to transmit the trip information to the independent moving object, cause the management system to:
transmit the trip information to cause the independent moving object to adjust the speed of the independent moving object to the speed of the group of moving objects,
wherein the speed of the independent moving object is adjusted to enable the independent moving object to travel with the group of moving objects.

20. The non-transitory computer-readable medium of claim 19, wherein, prior to transmitting the group information, the independent moving object is traveling on a first portion of a traveling path and the group of moving objects are traveling on a second portion of the traveling path,
wherein the speed of the independent moving object is a speed associated with the first portion of the traveling path,
wherein the speed of the group of moving objects is a speed associated with the first portion of the traveling path, and
wherein the one or more instructions, that cause the management system to transmit the trip information to the independent moving object, cause the management system to:
transmit the trip information to cause the independent moving object to travel at the speed associated with the second portion of the traveling path.
